(19) United States
(12) Patent Application Publication
(10) Pub. No.: US 2025/0019299 A1
(43) Pub. Date: Jan. 16, 2025

(54) METHODS FOR PRODUCING LOCALIZED CRYSTALLIZATION IN GLASS ARTICLES AND GLASS ARTICLES FORMED THEREFROM

(71) Applicant: CORNING INCORPORATED, CORNING, NY (US)

(72) Inventors: Nicolas LeBlond, Painted Post, NY (US); Irene Mona Peterson, Elmira Heights, NY (US); Joseph Martin Wright, Corning, NY (US)

(21) Appl. No.: 18/710,314

(22) PCT Filed: Nov. 1, 2022
(86) PCT No.: PCT/US2022/048549

§ 371 Date: May 15, 2024

Related U.S. Application Data
(60) Provisional application No. 63/280,820, filed on Nov. 18, 2021.

(51) Int. Cl. C03C 23/00; C03C 3/095; C03C 17/06

(52) U.S. Cl. CPC C03C 23/007; C03C 3/095; C03C 17/06; C03C 2201/02; C03C 2214/30

(57) ABSTRACT

Methods for producing localized crystallization in a glass article may include depositing a nucleation catalyst onto at least a portion of a surface of the glass article to form an at least partially coated surface. The nucleation catalyst may be in a solution or in a slurry. The method may include heating the glass article to a nucleation temperature and holding the glass article at the nucleation temperature to form a locally crystallized glass article comprising a crystalline phase and a non-crystalline phase. One or more portions of the locally crystallized glass article adjacent to the nucleation catalyst may include the crystalline phase and a remainder of the locally crystallized glass article may include the non-crystalline phase. The method may also include cooling the locally crystallized glass article.

### BACKGROUND

### Cross-Reference to Related Applications

This application claims the benefit of priority under 35 U.S.C. § 119 of U.S. Provisional Application No. 63/280,820, filed Nov. 18, 2021, the content of which is incorporated herein by reference in its entirety.

### FIELD

The present specification generally relates to glass articles and, more specifically, to methods for producing localized crystallization in glass articles.

### TECHNICAL BACKGROUND

Certain glass compositions may be treated, such as by thermal processing and the like, to form crystalline phases within the glass. However, certain families of glass compositions are resistant to crystallization. For example, some glasses have a high liquidus viscosity, which may make the glass resistant to crystallization. Accordingly, a need exists for methods promoting localized crystallization in glass articles that are resistant to crystallization.

Additionally, it may be desirable to form complex crystalline objects or glass articles that include a complex network of channels. Conventional methods for forming channels in a glass article or for forming complex crystalline objects may rely on machining or additive manufacturing. Such processes may lack the resolution desired for some applications. Accordingly, a need exists for methods for promoting localized crystallization in glass articles that allows the formation of complex channels in a glass body or complex crystalline objects.

### SUMMARY

According to a first aspect of the present disclosure, a method for producing localized crystallization in a glass article may include depositing a nucleation catalyst onto at least a portion of a surface of the glass article to form an at least partially coated surface. The nucleation catalyst may be in a solution or in a slurry. The method may include heating the glass article to a nucleation temperature and holding the glass article at the nucleation temperature to form a locally crystallized glass article comprising a crystalline phase and a non-crystalline phase. One or more portions of the locally crystallized glass article adjacent to the nucleation catalyst may include the crystalline phase and a remainder of the locally crystallized glass article may include the non-crystalline phase. The method may also include cooling the locally crystallized glass article.

A second aspect of the present disclosure may include the first aspect, wherein the nucleation catalyst comprises a Group 1 metal, a Group 2 metal, a Group 3 metal, a Group 4 metal, or Group 5 metal, or combinations thereof.

A third aspect of the present disclosure may include either the first or second aspect, wherein the nucleation catalyst comprises lithium, sodium, cesium, calcium, magnesium, strontium, scandium, yttrium, titanium, niobium, or combinations thereof.

A fourth aspect of the present disclosure may include any of the first through third aspects, wherein the nucleation catalyst comprises a metal carbonate, a metal nitrate, or combinations thereof.

A fifth aspect of the present disclosure may include any of the first through fourth aspects, wherein the nucleation catalyst comprises a metal oxide.

A sixth aspect of the present disclosure may include any of the first through fifth aspects, wherein the solution or the slurry further comprises water and diethylene glycol, and a weight ratio of water to diethylene glycol is from 2:1 to 1:2.

A seventh aspect of the present disclosure may include any of the first through sixth aspects, wherein the solution or the slurry has a viscosity from 1 centipoise to 25 centipoise and a surface tension from 20 dynes/centimeter to 50 dynes/centimeter.

An eighth aspect of the present disclosure may include any of the first through seventh aspects, wherein the glass article comprises fused silica.

A ninth aspect of the present disclosure may include any of the first through eighth aspects, wherein the glass article comprises an aluminosilicate glass.

A tenth aspect of the present disclosure may include any of the first through ninth aspects, wherein the glass article comprises sodium aluminosilicate glass, potassium aluminosilicate glass, calcium aluminosilicate glass, magnesium aluminosilicate glass, yttrium aluminosilicate glass, or sodium aluminosilicate phosphate glass.

An eleventh aspect of the present disclosure may include any of the first through tenth aspects, wherein the glass article has a liquidus temperature from 1,100° C. to 1,750° C.

A twelfth aspect of the present disclosure may include any of the first through eleventh aspects, wherein the glass article has a liquidus viscosity of greater than 35,000 poise.

A thirteenth aspect of the present disclosure may include any of the first through twelfth aspects, wherein the glass article has a liquidus viscosity of greater than 40,000 poise.

A fourteenth aspect of the present disclosure may include any of the first through thirteenth aspects, wherein the heating the glass article comprises heating the glass article at a rate from 1° C./minute to 10° C./minute.

A fifteenth aspect of the present disclosure may include any of the first through fourteenth aspects, wherein the holding the glass article at the nucleation temperature comprises holding the glass article at the nucleation temperature for a time in a range from 1 minute to 60 minutes.

A sixteenth aspect of the present disclosure may include any of the first through fifteenth aspects, wherein the nucleation temperature is from 650° C. to 1400° C.

A seventeenth aspect of the present disclosure may include any of the first through sixteenth aspects, wherein the glass article comprises an aluminosilicate glass and the nucleation temperature is from 650° C. to 850° C.

An eighteenth aspect of the present disclosure may include any of the first through seventeenth aspects, wherein a chemical composition of the crystalline phase is substantially the same as a chemical composition of the non-crystalline phase.

A nineteenth aspect of the present disclosure may include any of the first through eighteenth aspects, wherein a chemical composition of the crystalline phase is different from a chemical composition of the non-crystalline phase.

A twentieth aspect of the present disclosure may include any of the first through nineteenth aspects, wherein the method further comprises etching the locally crystallized glass article to remove at least a portion of the crystalline phase.

A twenty first aspect of the present disclosure may include any of the first through twentieth aspects, wherein the method further comprises etching the locally crystallized glass article to remove at least a portion of the non-crystalline phase.

According to a twenty second of the present disclosure, a method for producing localized crystallization in a glass article may include depositing a nucleation catalyst onto at least a portion of a surface of a first glass article to form an at least partially coated surface. The nucleation catalyst may be in a solution or in a slurry. The method may include fusing a second glass article to the first glass article to form a fused glass article. The at least partially coated surface may be positioned at an interface between the first glass article and the second glass article. The method may include heating the fused glass article to a nucleation temperature and holding the fused glass article at the nucleation temperature to form a locally crystallized glass article having a crystalline phase and a non-crystalline phase. One or more portions of the locally crystallized glass article adjacent to the nucleation catalyst may include the crystalline phase and a remainder of the locally crystallized glass article may include the non-crystalline phase. The method may also include cooling the locally crystallized glass article.

A twenty third aspect of the present disclosure may include the twenty second aspect, wherein the nucleation catalyst comprises a Group 1 metal, a Group 2 metal, a Group 3 metal, a Group 4 metal, or Group 5 metal, or combinations thereof.

A twenty fourth aspect of the present disclosure may include any of the twenty second through twenty third aspects, wherein the nucleation catalyst comprises lithium, sodium, cesium, calcium, magnesium, strontium, scandium, yttrium, titanium, niobium, or combinations thereof.

A twenty fifth aspect of the present disclosure may include any of the twenty second through twenty fourth aspects, wherein the nucleation catalyst comprises a metal carbonate, a metal nitrate, or combinations thereof.

A twenty sixth aspect of the present disclosure may include any of the twenty second through twenty fifth aspects, wherein the nucleation catalyst comprises a metal oxide.

A twenty seventh aspect of the present disclosure may include any of the twenty second through twenty sixth aspects, wherein the solution or the slurry further comprises water and diethylene glycol, and a weight ratio of water to diethylene glycol is from 2:1 to 1:2.

A twenty eighth aspect of the present disclosure may include any of the twenty second through twenty seventh aspects, wherein the solution or the slurry has a viscosity from 1 centipoise to 25 centipoise and a surface tension from 20 dynes/centimeter to 50 dynes/centimeter.

A twenty ninth aspect of the present disclosure may include any of the twenty second through twenty eighth aspects, wherein the first glass article comprises fused silica.

A thirtieth aspect of the present disclosure may include any of the twenty second through twenty ninth aspects, wherein the second glass article comprises fused silica.

A thirty first aspect of the present disclosure may include any of the twenty second through thirtieth aspects, wherein the first glass article comprises an aluminosilicate glass.

A thirty second aspect of the present disclosure may include any of the twenty second through thirty first aspects, wherein the second glass article comprises an aluminosilicate glass.

A thirty third aspect of the present disclosure may include any of the twenty second through thirty second aspects, wherein a composition of the first glass article may be substantially the same as a composition of the second glass article.

A thirty fourth aspect of the present disclosure may include any of the twenty second through thirty third aspects, wherein first glass article has a liquidus temperature from 1,100° C. to 1,750° C.

A thirty fifth aspect of the present disclosure may include any of the twenty second through thirty fourth aspects, wherein the second glass article has a liquidus temperature from 1,100° C. to 1,750° C.

A thirty sixth aspect of the present disclosure may include any of the twenty second through thirty fifth aspects, wherein the first glass article has a liquidus viscosity of greater than 35,000 poise.

A thirty seventh aspect of the present disclosure may include any of the twenty second through thirty sixth aspects, wherein the second glass article has a liquidus viscosity of greater than 35,000 poise.

A thirty eighth aspect of the present disclosure may include any of the twenty second through thirty seventh aspects, wherein the heating the fused glass article comprises heating the fused glass article at a rate from 1° C./minute to 10° C./minute.

A thirty ninth aspect of the present disclosure may include any of the twenty second through thirty eighth aspects, wherein the holding the fused glass article at the nucleation temperature comprises holding the fused glass article at the nucleation temperature for a time in a range from 1 minute to 60 minutes.

A fortieth aspect of the present disclosure may include any of the twenty second through thirty ninth aspects, wherein the nucleation temperature is from 650° C. to 1400° C.

A forty first aspect of the present disclosure may include any of the twenty second through fortieth aspects, wherein a chemical composition of the crystalline phase is substantially the same as a chemical composition of the non-crystalline phase.

A forty second aspect of the present disclosure may include any of the twenty second through forty first aspects, wherein a chemical composition of the crystalline phase is different from a chemical composition of the non-crystalline phase.

A forty third aspect of the present disclosure may include any of the twenty second through forty second aspects, wherein the method further comprises etching the locally crystallized glass article to remove at least a portion of the crystalline phase.

A forty fourth aspect of the present disclosure may include any of the twenty second through forty third aspects, wherein the method further comprises etching the locally crystallized glass article to remove at least a portion of the non-crystalline phase.

According to a forty fifth aspect of the present disclosure, a locally crystallized glass article may include a crystalline phase and a non-crystalline phase, wherein a liquidus viscosity of the non-crystalline phase is greater than or equal to 35,000 poise.

A forty sixth aspect of the present disclosure may include the forty fifth aspect, wherein the liquidus viscosity of the non-crystalline phase is greater than or equal to 40,000 Poise.

A forty seventh aspect of the present disclosure may include any of the forty fifth through forty sixth aspects, wherein a chemical composition of the crystalline phase is different from a chemical composition of the non-crystalline phase.

A forty eighth aspect of the present disclosure may include any of the forty fifth through forty seventh aspects, wherein a chemical composition of the crystalline phase is substantially the same as a chemical composition of the non-crystalline phase.

A forty ninth aspect of the present disclosure may include any of the forty fifth through forty eighth aspects, wherein the non-crystalline phase comprises fused silica.

A fiftieth aspect of the present disclosure may include any of the forty fifth through forty ninth aspects, wherein the non-crystalline phase comprises sodium aluminosilicate glass, calcium aluminosilicate glass, magnesium aluminosilicate glass, yttrium aluminosilicate glass, or sodium aluminosilicate phosphate glass.

A fifty first aspect of the present disclosure may include the fiftieth, wherein the sodium aluminosilicate glass comprises from 11.5 mol. % to 13.5 mol. % Na2O; from 7.5 mol. % to 17.5 mol. % Al2O3; from 70.0 mol. % to 80.0 mol. % SiO2; and from 0.10 mol. % to 0.20 mol. % SnO2.

A fifty second aspect of the present disclosure may include the fiftieth, wherein the calcium aluminosilicate glass comprises from 24.0 mol. % to 20.0 mol. % CaO; from 20.0 mol. % to 30.0 mol. % Al2O3; from 45.0 mol. % to 55.0 mol. % SiO2; and from 0.10 mol. % to 0.20 mol. % SnO2.

A fifty third aspect of the present disclosure may include the fiftieth, wherein the magnesium aluminosilicate glass comprises from 24.0 mol. % to 26.0 mol. % MgO; from 20.0 mol. % to 30.0 mol. % Al2O3; from 45.0 mol. % to 55.0 mol. % SiO2; and from 0.10 mol. % to 0.20 mol. % SnO2.

A fifty fourth aspect of the present disclosure may include the fiftieth, wherein the yttrium aluminosilicate glass comprises from 23.1 mol. % to 25.1 mol. % Y₂O3; from 27.3 mol. % to 37.3 mol. % Al2O3; from 38.5 mol. % to 47.5 mol. % SiO2; and from 0.05 mol. % to 0.15 mol. % SnO2.

A fifty fifth aspect of the present disclosure may include the fiftieth, wherein the yttrium aluminosilicate glass comprises from 27.4 mol. % to 29.4 mol. % Y₂O3; from 17.9 mol. % to 27.9 mol. % Al2O3; from 43.6 mol. % to 53.6 mol. % SiO2; and from 0.05 mol. % to 0.15 mol. % SnO2.

A fifty sixth aspect of the present disclosure may include the fiftieth, wherein the sodium aluminosilicate phosphate glass comprises from 11.3 mol. % to 13.3 mol. % Na₂O; from 0.4 mol. % to 2.4 mol. % P₂O₅; from 7.3 mol. % to 17.3 mol. % Al₂O₃; from 68.9 mol. % to 78.8 mol. % SiO₂; and from 0.05 mol. % to 0.15 mol. % SnO2.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an isometric view of a glass article according to one or more embodiments described herein;

FIG. 2A schematically depicts an isometric view of a glass article according to one or more embodiments described herein:

FIG. 2B schematically depicts a side view of a glass article according to one or more embodiments described herein:

FIG. 3 schematically depicts a side view of a locally crystallized glass article according to one or more embodiments described herein:

FIG. 4 schematically depicts a side view of a fused glass article according to one or more embodiments described herein:

FIG. 5 schematically depicts a side view of a locally crystallized glass article according to one or more embodiments described herein;

FIG. 6 is a photograph of a locally crystallized fused silica glass article according to Example 3 as described herein; and

FIG. 7 is an x-ray diffraction spectrum of the crystalline phase of an yttrium aluminosilicate glass article according to Example 3 as described herein.

### DETAILED DESCRIPTION

Reference will now be made in detail to various embodiments of methods for producing localized crystallization in glass articles. Whenever possible, the same reference numerals will be used throughout the drawings to refer to the same or like parts. In embodiments, methods for producing localized crystallization as described herein may include the steps of depositing an ink onto at least a portion of a surface of a glass article to form an at least partially coated surface; heating the glass article to a nucleation temperature; holding the glass article at the nucleation temperature to form a locally crystallized glass article; and cooling the locally crystallized glass article. Methods for producing localized crystallization in glass articles and glass articles formed therefrom will be described in further detail herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

It may be desirable to form crystalline phases in glass articles. For example, the nucleation of crystalline phases in a glass article may be utilized to enhance are alter one or more properties of a glass article, such as mechanical properties, optical properties, or chemical properties. For example, crystalline phases formed in a glass network may have different chemical properties than the remaining portions of the glass network, allowing for the crystalline phases (or the glass network) to be selectively removed, such as by etching. Such selective removal may produce a desired structure or pattern in the article.

However, not all glass compositions are amenable to the nucleation of crystalline phases in the glass network. For example, some glass compositions may have very high liquidus viscosities that prevent the nucleation of crystalline phases. In embodiments glass compositions having a liquidus viscosity greater than or equal to 35,000 Poise may be difficult to nucleate. The methods described herein may be used to facilitate the nucleation of crystalline phases, including the selective nucleation of crystalline phases in certain portions of the glass. Such methods are effective for producing crystalline phases in glass compositions that are not otherwise amenable to the nucleation of crystalline phases and may also be used to produce localized crystallization in glasses that are susceptible to the formation of crystalline phases through conventional techniques (i.e., glasses susceptible to bulk nucleation through heat treatment).

As used in the present disclosure, the term “liquidus viscosity” refers to the viscosity of the glass composition at the onset of devitrification (i.e., at the liquidus temperature as determined with the gradient furnace method according to ASTM C829-81).

As used in the present disclosure, the term “liquidus temperature” refers to the temperature at which the glass composition begins to devitrify as determined with the gradient furnace method according to ASTM C829-81.

As used in the present disclosure, the term “annealing point” (also referred to herein as the “annealing temperature”) refers to the temperature at which the viscosity of the glass composition is 1×10^{13.18} poise. The annealing point of a glass may be measured according to ASTM 1350.

The methods for producing localized crystallization in glass articles may comprise depositing a nucleation catalyst onto at least a portion of a surface of the glass article to form an at least partially coated surface. In embodiments, the nucleation catalyst may comprise a Group 1 metal, a Group 2 metal, a Group 3 metal, a Group 4 metal, a Group 5 metal, or combinations thereof. As used throughout the present disclosure, groups of elements refer to the Groups of the International Union of Pure and Applied Chemistry (IUPAC) Periodic Table. For example, a “Group 1 metal” refers to any metal in Group 1 of the IUPAC Periodic Table. In embodiments, the nucleation catalyst may comprise lithium (Li), sodium (Na), cesium (Cs), calcium (Ca), magnesium (Mg), strontium (Sr), scandium (Sc), yttrium (Y), titanium (Ti), niobium (Nb), zirconium (Zr), or combinations thereof. Without intending to be bound by theory, the nucleation catalyst may be operable to promote localized crystallization of the glass article in portions of the glass article that are adjacent to the nucleation catalyst.

The nucleation catalyst may be present in a solution or in a slurry when it is deposited onto the surface of the glass article. For example, the nucleation catalyst may be dissolved in a liquid such that the nucleation catalyst is present in a solution. Alternatively, the nucleation catalyst may be suspended in a liquid such that the nucleation catalyst is present in a slurry.

In embodiments, the nucleation catalyst may be present in the solution or slurry as a metal carbonate, a metal nitrate, or combinations of these. For example and without limitation, a nucleation catalyst comprising sodium may comprise sodium bicarbonate. In embodiments, the nucleation catalyst may comprise lithium nitrate, sodium bicarbonate, sodium nitrate, cesium nitrate, calcium nitrate, scandium nitrate, or combinations of these.

In embodiments, the nucleation catalyst may be present in the solution or slurry as a metal oxide. For example and without limitation, a nucleation catalyst comprising titanium may comprise titanium oxide. In embodiments, the nucleation catalyst may comprise yttrium oxide, titanium oxide, niobium oxide, or combinations of these. In embodiments, the nucleation catalyst may be present in the solution or slurry as an inorganic compound. For example and without limitation, the nucleation catalyst may comprise zirconyl chloride.

In embodiments, the concentration of the nucleation catalyst in the solution or slurry may be from 0.01 moles/liter (M) to 1.0 M. For example and without limitation, the concentration of the nucleation catalyst in the solution or slurry may be from 0.01 M to 1.0 M, from 0.03 M to 0.8 M, from 0.05 M to 0.5 M, from 0.7 M to 0.3 M, from 0.09 M to 0.2 M, or any combination or subset of these ranges. Without intending to be bound by theory, if the concentration of nucleation catalyst in the solution or slurry is too low, then a large amount of solution or slurry would be deposited on the glass article to promote crystallization and it may be difficult to control the area in which the glass article crystallizes. On the other hand, if the concentration of nucleation catalyst is too high, then nucleation catalyst may precipitate out of the solution or settle out of the slurry making it difficult to deposit the nucleation catalyst onto the glass article.

The solution or slurry may further comprise water and diethylene glycol. In embodiments, the weight ratio of water to diethylene glycol may be from 2:1 to 1:2. For example and without limitation, the weight ratio of water to diethylene glycol may be from 2:1 to 1:2, from 1.5:1 to 1:2, from 1:1 to 1:2, from 1:1.5 to 1:2, from 2:1 to 1:1.5, from 2:1 to 1:1, from 2:1 to 1.5:1, or any combination or subset of these ranges.

In embodiments, the solution or slurry may have a viscosity from 1 centipoise (cP) to 25 cP. For example and without limitation, the solution or slurry may have a viscosity from 1 cP to 25 cP, from 5 cP to 25 cP, from 10 cP to 25 cP, from 15 cP to 25 cP, from 20 cP to 25 cP, from 1 cP to 20 cP, from 1 cP to 15 cP, from 1 cP to 10 cP, from 1 cP to 5 cP, or any combination or subset of these ranges. The solution or slurry may have a surface tension from 20 dynes/centimeter (dyn/cm) to 50 dyn/cm. For example and without limitation, the solution or slurry may have a surface tension from 20 dyn/cm to 50 dyn/cm, from 25 dyn/cm to 50 dyn/cm, from 30 dyn/cm to 50 dyn/cm, from 35 dyn/cm to 50 dyn/cm, from 40 dyn/cm to 50 dyn/cm, from 45 dyn/cm to 50 dyn/cm, from 20 dyn/cm to 45 dyn/cm, from 20 dyn/cm to 40 dyn/cm, from 20 dyn/cm to 35 dyn/cm, from 20 dyn/cm to 30 dyn/cm, from 20 dyn/cm to 25 dyn/cm, or any combination or subset of these ranges.

In embodiments, the solution or slurry may be deposited onto the surface of the glass article by an inkjet printer. Without intending to be bound by theory, the solution or slurry may be suitable for use in an inkjet printer when the viscosity of the solution or slurry is from 1 cP to 20 cP and the surface tension of the solution or slurry is from 20 dyn/cm to 50 dyn/cm. Such viscosity and surface tension may be achieved by including water and diethylene glycol in the solution or slurry in a ratio from 2:1 to 1:2.

While the solution or slurry containing the nucleation catalyst is described herein as being deposited via inkjet printing, it should be noted that the solution or slurry may be deposited onto the surface of the glass article by any suitable means, not limited to inkjet printing as described herein. In embodiments where alternative printing or deposition techniques for applying the solution or slurry onto the surface of the glass article are used, the solution or slurry containing the nucleation catalyst may have a composition and physical properties (e.g., viscosity, surface tension, etc.) such that the solution or slurry is suitable for use in the depositing means being used.

The glass article may comprise any glass that may be locally crystallized by the presently described methods. Without intending to be bound by theory, a glass article may be able to be locally crystallized by the methods described herein when the nucleation catalyst is operable to reduce the crystallization temperature of the portions of the glass article adjacent to the nucleation catalyst below the crystallization temperature of the remainder of the glass article.

In embodiments, the glass article may comprise amorphous silica. In embodiments, amorphous silica may include fused quarts or fused silica. As described herein, “fused quartz” refers to amorphous silica made by melting quartz. As described herein, “fused silica” refers to amorphous silica made by chemical means including but not limited to sol-gel processes and combustion of silicon-containing precursors. In embodiments, the glass article may comprise an aluminosilicate glass. As described herein, “aluminosilicate glass” refers to a glass including aluminum, silicon, oxygen, and countercations. For example, the glass article may comprise sodium aluminosilicate glass, calcium aluminosilicate glass, magnesium aluminosilicate glass, yttrium aluminosilicate glass, or sodium aluminosilicate phosphate glass. In one or more embodiments, the glass article may comprise a sodium aluminosilicate glass, calcium aluminosilicate glass, magnesium aluminosilicate glass, yttrium aluminosilicate glass, or sodium aluminosilicate phosphate glass having a composition as shown in Table 1.

TABLE 1
Glass Compositions (mol. %)

| | Sodium | Calcium | Magnesium | Yttrium | Yttrium | Sodium |
|---|---|---|---|---|---|---|
| | Aluminosilicate | Aluminosilicate | Aluminosilicate | Aluminosilicate | Aluminosiliate | Aluminosilicate |
| | Glass | Glass | glass | Glass 1 | Glass 2 | Phosphate Glass |
| Na₂O | 11.5-13.5 | | | | | 11.3-13.3 |
| CaO | | 24.0-20.0 | | | | |
| MgO | | | 24.0-26.0 | | | |
| Y₂O₃ | | | | 23.1-25.1 | 27.4-29.4 | |
| Al₂O₃ | 7.5-17.5 | 20.0-30.0 | 20.0-30.0 | 27.3-37.3 | 17.9-27.9 | 7.3-17.3 |
| SiO₂ | 70.0-80.0 | 45.0-55.0 | 45.0-55.0 | 38.5-47.5 | 43.6-53.6 | 68.9-78.8 |
| P₂O₅ | | | | | | 0.4-2.4 |
| SnO₂ | 0.10-0.20 | 0.10-0.20 | 0.10-0.20 | 0.05-0.15 | 0.05-0.15 | 0.05-0.15 |

The glass article may have a liquidus temperature from 1,100 degrees Celsius (° C.) to 1,750° C. For example and without limitation, the glass article may have a liquidus temperature from 1,100° C. to 1,750° C., from 1,200° C. to 1,750° C., from 1,300° C. to 1,750° C., from 1,400° C. to 1,750° C., from 1,500° C. to 1,750° C., from 1,600° C. to 1,750° C., from 1,700° C. to 1,750° C., from 1,100° C. to 1,700° C., from 1,100° C. to 1,600° C., from 1,100° C. to 1,500° C., from 1,100° C. to 1,400° C., from 1,100° C. to 1,300° C., from 1,100° C. to 1,200° C., or any combination or subset of these ranges. As described herein, “liquidus temperature” refers to the temperature above which the material is completely liquid. The liquidus temperature may be the maximum temperature at which crystals may coexist with a liquid phase of the material.

In embodiments, the glass article may have a liquidus viscosity of greater than 35,000 poise (P). For example and without limitation, the glass article may have a liquidus viscosity of greater than 35,000 P, 40,000 P, 50,000 P, 60,000 P, 70,000 P, 80,000 P, 90,000 P or 100,000 P. As described herein, “liquidus viscosity” refers to the viscosity of a material at its liquidus temperature. Without intending to be bound by theory, when a material has a high liquidus viscosity, the material is highly bonded and it is relatively difficult for the bonds to twist or move. In other words, a material having a high liquidus viscosity has a structure that is mechanically stiff. Accordingly, a material with a high liquidus viscosity may be relatively difficult to crystallize, as it may be difficult for the bonds to rearrange into a crystalline structure. It is contemplated that the nucleation catalyst may loosen the bonds in a portion of the glass article adjacent to the nucleation catalyst such that the crystals may nucleate and grow in the portion of the glass article adjacent to the nucleation catalyst.

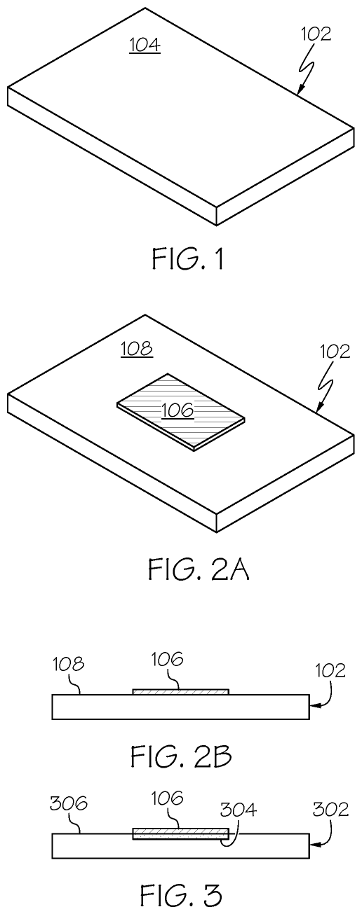

Referring now to FIG. 1, a glass article 102 may comprise a surface 104. As shown in FIGS. 2A and 2B, solution or slurry 106 comprising a nucleation catalyst may be deposited on at least a portion of surface 104 of the glass article 102 to form an at least partially coated surface 108. In embodiments, the solution or slurry 106 may partially coat the surface 108. In embodiments, the solution or slurry 106 may completely coat (not depicted) the surface 108. The solution or slurry 106 may be deposited onto a single area of the surface 108 of the glass article 102, such that the area of the at least partially coated surface 108 covered by the solution or slurry 106 is continuous. In embodiments, the solution or slurry 106 may be deposited onto multiple areas of the surface 108 of the glass article 102 (not depicted), such that the area of the at least partially coated surface 108 covered by the solution or slurry 106 is discontinuous. It is contemplated that the solution or slurry 106 may be deposited onto the surface 108 of the glass article 102 in a variety of patterns, such as simple shapes, text, relatively complex shapes, or even patterns. It should be noted that the depictions of the glass article 102 and solution or slurry 106 in FIGS. 2A and 2B are not necessarily drawn to scale and serve merely as an illustration of the glass article 102.

The methods for producing localized crystallization in a glass article includes heating the glass article to a nucleation temperature. In embodiments, heating the glass article may comprise heating the glass article at a rate from 1 degree Celsius/minute (° C./min.) to 10° C./min. For example and without limitation, heating the glass article may comprise heating the glass article at a rate from 1° C./min. to 10° C./min., from 3° C./min. to 10° C./min., from 5° C./min. to 10° C./min., from 7° C./min. to 10° C./min., from 9° C./min. to 10° C./min., from 1° C./min. to 8° C./min., from 1° C./min. to 6° C./min., from 1° C./min. to 4° C./min., from 1° C./min. to 2° C./min., or any combination or subset of these ranges.

As described herein, “nucleation temperature” refers to a temperature at which the nucleation catalyst is operable to promote crystallization in the glass article. In embodiments, the nucleation temperature may be from 650° C. to 1,400° C. For example and without limitation, the nucleation temperature may be from 650° C. to 1,400° C., from 700° C. to 1,400° C., from 800° C. to 1,400° C., from 900° C. to 1,400° C., from 1,000° C. to 1,400° C., from 1,100° C. to 1,400° C., from 1,200° C. to 1,400° C., from 1,300° C. to 1,400° C., from 650° C. to 1,300° C., from 650° C. to 1,200° C., from 650° C. to 1,100° C., from 650° C. to 1,000° C., from 650° C. to 900° C., from 650° C. to 800° C., from 650° C. to 700° C., or any combination or subset of these ranges.

It is contemplated that the nucleation temperature may vary depending on the composition of the glass article. For example, in embodiments where the glass article comprises an aluminosilicate glass, the nucleation temperature may be from 650° C. to 850° C. For example and without limitation, when the glass article comprise an aluminosilicate glass, the nucleation temperature may be from 650° C. to 850° C., from 650° C. to 800° C., from 650° C. to 750° C., from 650° C. to 700° C., from 700° C. to 850° C., from 750° C. to 850° C., from 800° C. to 850° C., or any combination or subset of these ranges. In embodiments where the glass article comprises amorphous silica, the nucleation temperature may be from about 1100° C. to about 1,400° C. For example and without limitation, when the glass article comprises amorphous silica, the nucleation temperature may be from 1,100° C. to 1,400° C., from 1,200° C. to 1,400° C., from 1,300° C. to 1,400° C., from 1,100° C. to 1,300° C., from 1,100° C. to 1,200° C., or any combination or subset of these ranges. Without intending to be bound by theory, the nucleation temperature may be a function of the viscosity of the glass article where higher nucleation temperature is expected from glass articles having higher viscosities.

In embodiments the nucleation temperature may be less than or equal to the annealing temperature of the glass article. In embodiments, the nucleation temperature may be between the softening temperature and the annealing temperature. As described herein, the “annealing temperature” refers to a temperature at which the glass is hard enough to not deform externally, yet soft enough that internal stress within the glass may be reduced. In embodiments, the nucleation temperature may be less than the annealing temperature and deviate from the annealing temperature by less than 10%, less than 5%, or even less than 2%.

The glass article may be heated in any apparatus suitable for heating the glass article to the nucleation temperature. For example, the glass article may be heated in any suitable kiln, oven, furnace, or other heating apparatus.

The method for producing localized crystallization in a glass article includes holding the glass article at the nucleating temperature to form a locally crystallized glass article. Referring now to FIG. 3, the locally crystallized glass article 302 may comprise a crystalline phase 304 and a non-crystalline phase 306. In embodiments, one or more portions of the locally crystallized glass article 302 adjacent to the solution or slurry 106 comprise the crystalline phase 304 and a remainder of the locally crystallized glass article 302 comprises the non-crystalline phase 306. It should be noted that the depictions of the crystalline phase 304 and the non-crystalline phase 306 in the locally crystallized glass article 302 and the solution or slurry 106 in FIG. 3 are not necessarily drawn to scale and serve merely as an illustration of the locally crystallized glass article 302.

Without intending to be bound by theory, when the glass article is at the nucleation temperature, the nucleation catalyst may diffuse from the solution or slurry into the glass article. The nucleation catalyst, once diffused into the glass article, may promote localized crystallization of the glass article in the portions of the glass article into which the nucleation catalyst has diffused. According to embodiments, the areas of the glass article that are “adjacent to the solution or slurry” may be the areas of the glass article into which the nucleation catalyst has diffused.

In embodiments, one or more portions of the locally crystallized glass article may be adjacent to the solution or slurry. In embodiments where the solution or slurry is deposited onto the surface of the glass article such that the area of the at least partially coated surface covered by the solution or slurry is continuous, the locally crystallized glass article may comprise a single portion adjacent to the solution or slurry. In embodiments where the solution or slurry is deposited onto multiple areas of the surface of the glass article such that the area of the at least partially coated surface covered by the solution or slurry is discontinuous, the locally crystallized glass article may comprise multiple portions adjacent to the solution or slurry.

Without intending to be bound by theory, the portions of the glass article into which the nucleation catalyst does not diffuse generally do not crystallize. According to embodiments, the remainder of the locally crystallized glass article may refer to one or more portions of the locally crystallized glass article into which the nucleation catalyst does not diffuse, such that the portions of the glass article do not crystallize. In embodiments, the chemical composition of the non-crystalline phase, the remainder of the locally crystallized glass article, may be substantially the same as the chemical composition of the glass article prior to crystallization.

In embodiments, a chemical composition of the crystalline phase is substantially the same as the chemical composition of the non-crystalline phase. For example, the non-crystalline phase may comprise silicon dioxide when the glass article is amorphous silica and the crystalline phase may comprise cristobalite, which also comprises silicon dioxide. In embodiments, a chemical composition of the crystalline phase may be different from the chemical composition of the non-crystalline phase. For example and without limitation, the non-crystalline phase may comprise a yttrium aluminosilicate glass and the crystalline phase may comprise aluminum niobium oxide after the glass article is treated with an solution or slurry comprising a niobium oxide nucleation catalyst.

In embodiments, the crystalline phase may comprise one or more of cristobalite, tridymite, quartz, forsterite, strontium silicate, calico-olivine, lamite, anorthite, clinoenstatite, and aluminum niobium oxide. It should be noted that the composition of the crystalline phase may depend on the composition of the glass article and the composition of the nucleation catalyst.

The method for producing localized crystallization in a glass article includes cooling the glass article. The glass article may be cooled by any suitable means and at any suitable rate. For example and without limitation, the cooling may include removing the glass article from the furnace and allowing the glass article to cool to room temperature in the ambient atmosphere. Alternatively, the glass article may be cooled to room temperature at a set rate within the furnace. In yet another alternative, the glass article may be cooled to room temperature by furnace cooling, wherein the glass article remains in the furnace with the furnace switched off until the glass article cools to room temperature.

In embodiments, the method may further comprise etching the locally crystallized glass article to remove at least a portion of the crystalline phase. In embodiments, the etching may remove substantially all of the crystalline phase to produce an etched glass article. The etched glass article may comprise one or more cavities or recesses at the location or locations of the crystalline phase of the locally crystallized glass article. In embodiments, the etched glass article may comprise one or more channels in a desired location. Such etched glass articles may be useful in the formation of micro-reactors or micro-optics.

In embodiments, the method may further comprise etching the locally crystallized glass article to remove at least a portion of the non-crystalline phase. In embodiments, the etching may remove substantially all of the non-crystalline phase to produce a crystalline article. Without intending to be bound by theory, it may be possible to produce crystalline articles using the method described herein that have complex shapes that cannot be achieved by conventional machining methods or additive manufacturing methods. For example, it may be possible to produce crystalline articles that are highly porous, or include a tight lattice structure, using the methods described herein.

In embodiments, methods for producing localized crystallization in a glass article may include depositing a nucleation catalyst onto at least a portion of a surface of a first glass article to form an at least partially coated surface, as described hereinabove. The method may further comprise fusing a second glass article to the first glass article to form a fused glass article, where the at least partially coated surface of the first glass article is positioned at an interface between the first glass article and the second glass article.

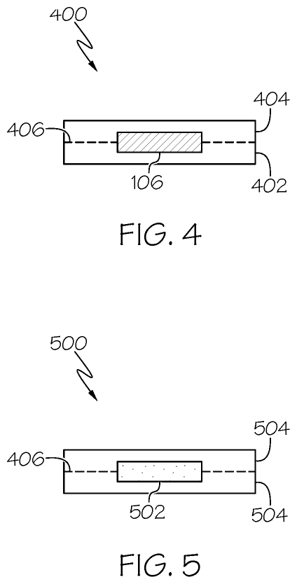

Referring now to FIG. 4, a first glass article 402 may be fused to a second glass article 404 to form a fused glass article 400. The first glass article 402 may be fused to the second glass article 404 such that there is an interface 406 between the first glass article 402 and the second glass article 404. The solution or slurry 106 comprising a nucleation catalyst may be positioned at the interface 406 between the first glass article 402 and the second glass article 404. It should be noted that the depiction of the fused glass article 400 in FIG. 4 is not necessarily drawn to scale and serves merely as in illustration of the fused glass article 400.

In embodiments, the first glass article and the second glass article may each be a glass article as described hereinabove. In embodiments, the composition of the first glass article may be substantially the same as the composition of the second glass article. For example and without limitation, the first glass article and the second glass article may both be amorphous silica.

In embodiments, the second glass article may be fused to the first glass article by any suitable means. For example without limitation, the second glass article may be fused to the first glass article by stacking the first glass article and the second glass article and then heating the glass articles in a furnace until the surfaces of the glass articles soften enough to stick together. For examples without limitation, the glass articles may be heated to the softening point of the glass articles during the fusing process. In embodiments, the fused glass article may be heated to a nucleation temperature and held at the nucleation temperature to form a locally crystallized glass article comprising a crystalline phase and a non-crystalline phase, as described hereinabove. Additionally, the method may include cooling the locally crystallized glass article.

Referring now to FIG. 5, a locally crystallized glass article 500 may include a crystalline phase 502 and a non-crystalline phase 504. In embodiments, one or more portions of the locally crystallized glass article 500 adjacent to the interface 406 between the first glass article and the second glass article, where the solution or slurry 106 is positioned as depicted in FIG. 4, may comprise the crystalline phase 502. It is contemplated that the crystalline phase 502 spans the interface 406 in embodiments. A remainder of the locally crystallized glass article 500 may include the non-crystalline phase 504. It should be noted that the depiction of the locally crystallized glass article 500 in FIG. 5 is not necessarily drawn to scale and serves merely as in illustration of the locally crystallized glass article 500.

It should be understood that the methods described herein may include more than two glass articles. In embodiments, three, four, five, or even more glass articles may be fused together. In such embodiments, a nucleating catalyst may be present at the interface between each of the glass articles, or only some of the interfaces between glass articles. It is contemplated that utilizing multiple layers of glass articles and nucleating catalyst may be useful for making three dimensional shapes or patterns of crystallized glass through a glass article.

In embodiments the method may include etching the locally crystallized glass article formed from the fused glass article. In embodiments, the locally crystallized glass article may be etched to remove at least a portion of the crystalline phase to produce an etched glass article. The etched glass article may comprise one or more cavities, channels, or recesses at the location of the crystalline phase of the locally crystallized glass article. It is contemplated that etching a

In embodiments, the locally crystallized glass article may be etched to remove at least a portion of the non-crystalline phase to produce a crystalline article. It is contemplated that using a fused glass article having multiple layers of glass articles in contact with nucleation catalyst may allow the production of three dimensional shapes or patterns of crystallized material. In embodiments, etching the locally crystallized glass article may produce a crystalline article having a relatively complex three dimensional shape or pattern, such as a porous crystalline article. It is contemplated that the methods described herein may be used to form etched glass articles or crystalline articles having relatively complex shapes without the use of machining, photo lithography, or other similar methods.

### EXAMPLES

The embodiments described herein will be further clarified by the following examples.

### Example 1—Nucleating Catalyst Solutions and Slurries

Solutions and slurries including nucleation catalysts suitable for use in an inkjet printer were formed. For a fluid to be useable in an inkjet printer the viscosity of the fluid should be from 1 cP to 25 cP and the surface tension of the fluid should be from 20 dyn/cm to 50 dyn/cm. Dilute aqueous salt solutions typically have a viscosity of about 1 cP since they are mostly water; however, they generally have a high surface tension of about 72 dyn/cm. Surface tension of the solution may be reduced by adding diethylene glycol to the solution until the surface tension is below 50 dyn/cm. Solutions and slurries including water and diethylene glycol (99%; Alfa Aesar) in a 1:1 ratio and a nucleation catalyst were formed. The target concentration of nucleation catalyst in each of the solutions was 0.1 M. The nucleation catalysts used in each of the solutions or slurries are listed in Table 2. Additionally, Table 2 includes the amount of nucleation catalyst used to produce 20 ml of a 0.1 M solution or slurry of nucleation catalyst in the mixture of water and diethylene glycol. The nucleation catalysts listed in Table 2 formed either a solution or a slurry depending on the solubility of the nucleation catalyst in the water/diethylene glycol mixture.

TABLE 2
Nucleation Catalyst Properties

| Nucleation | | Molar mass | Melting | Decomp. | Weight |
|---|---|---|---|---|---|
| Catalyst | Origin | (g/mol) | point | (° C.) | (g) |
| LiNO₃ | Acros 99+% | 68.946 | 255 | 600 | 0.138 |
| NaHCO₃ | Arm & | 84.0066 | 851 | — | 0.168 |
| | Hammer | | | | |
| NaNO₃ | Unknown | 84.9947 | 308 | 380 | 0.170 |
| CsNO₃ | Alfa Aesar | 194.91 | 414 | — | 0.390 |
| | 99.8% | | | | |
| Ca(NO₃)₂ · | Fischer ACS | 236.15 | 560 | >500 | 0.472 |
| 4H₂O | | | | | |
| Sc(NO₃)₃ · | Alfa Aesar | 303.03 | — | — | 0.606 |
| 4H₂O | 99.9% | | | | |
| Y₂O₃ | Aldrich <50 nm | 225.81 | 2425 | — | 0.452 |
| TiO₂ | Aldrich | 79.866 | 1843 | — | 0.160 |
| | <100 nm | | | | |
| ZrOCl₂ · | Acros 98+% | 322.25 | — | — | 0.645 |
| 8H₂O | | | | | |
| Nb₂O₅ | Alfa Aesar | 265.81 | 1512 | — | 0.532 |
| | 99.9985% | | | | |
| Mg(NO₃) | Fisher ACS | 256.41 | 330 | — | 0.513 |

### Example 2—Glass Articles

The nucleation catalyst solutions and slurries of Example 1 were tested on glass articles described in the present example. The glass articles include fused quartz glass, sodium aluminosilicate glass, calcium aluminosilicate glass, magnesium aluminosilicate glass, a first yttrium aluminosilicate glass, a second yttrium aluminosilicate glass, and a sodium aluminosilicate phosphate glass. The fused quarts glass includes 100 mol. % SiO₂. The compositions of the sodium aluminosilicate glass, calcium aluminosilicate glass, magnesium aluminosilicate glass, a first yttrium aluminosilicate glass, a second yttrium aluminosilicate glass, and a sodium aluminosilicate phosphate glass are given in Table 3.

TABLE 3
Glass Compositions (mol. %)

| | Sodium | Calcium | Magnesium | Yttrium | Yttrium | Sodium |
|---|---|---|---|---|---|---|
| | Aluminosilicate | Aluminosilicate | Aluminosilicate | Aluminosilicate | Aluminosiliate | Aluminosilicate |
| | Glass | Glass | glass | Glass 1 | Glass 2 | Phosphate Glass |
| Na₂O | 12.5 | | | | | 12.3 |
| CaO | | 25.0 | | | | |
| MgO | | | 25.0 | | | |
| Y₂O₃ | | | | 24.1 | 28.4 | |
| Al₂O₃ | 12.5 | 25.0 | 25.0 | 32.3 | 22.9 | 12.3 |
| SiO₂ | 75.0 | 50.0 | 50.0 | 43.5 | 48.6 | 73.9 |
| P₂O₅ | | | | | | 1.4 |
| SnO₂ | 0.13 | 0.15 | 0.15 | 0.11 | 0.11 | 0.08 |

The liquidus temperature and liquidus viscosity for each of the glass articles is given in Table 4.

TABLE 4
Liquidus Temperatures and Viscosities

| | Liquidus | Liquidus |
|---|---|---|
| | Temperature, | Viscosity, |
| Glass Name | ° C. | Poise |
| Fused quartz | 1726 | NA |
| Sodium Aluminosilicate | 1129 | 151,530,480 |
| Calcium Aluminosilicate | 1553 | 81 |
| Magnesium Aluminosilicate | 1549 | 42 |
| Yttrium Aluminosilicate 1 | 1520 | 10.5 |
| Yttrium Aluminosilicate 2 | 1508 | 4.5 |
| Sodium Aluminosilicate | 1102 | 43,221,516 |
| Phosphate | | |

### Example 3—Localized Crystallization

The nucleating catalyst solutions or slurries of Example 1 were applied to the glass articles of Example 2 by an inkjet printer. Each of the glass articles was heated to a nucleating temperature at a rate of 5° C./minute. The nucleating temperature of each glass article of Example 2 is given in Table 5.

TABLE 5
Nucleation Temperatures

| | Nucleating |
|---|---|
| Glass Name | Temperature, ° C. |
| Fused Quartz | 1400 |
| Sodium Aluminosilicate | 650 |
| Calcium Aluminosilicate | 770 |
| Magnesium Aluminosilicate | 820 |
| Yttrium Aluminosilicate 1 | 820 |
| Yttrium Aluminosilicate 2 | 820 |
| Sodium Aluminosilicate Phosphate | 570 |

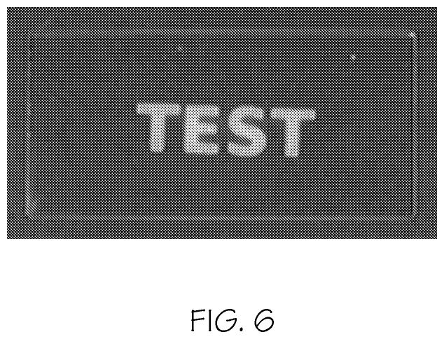

The temperature at which crystallization began, referred to as the crystal onset temperature, was observed for some of the glass samples. For the samples that crystallized, the crystal phase and the composition of the crystal phase were determined. The crystal onset temperature, the crystal phase, and composition of the crystal phase for the fused quartz glass article samples of Example 2 are displayed in Table 6. FIG. 6 depicts a fused quartz glass article where the text “TEST” is locally crystallized on the glass article using a sodium nucleating catalyst. Additionally, it should be noted that localized crystallization was not observed for each nucleating catalyst on each glass article.

TABLE 6
Crystallization of Fused Quartz Glass of Example 2

| Nucleation | Crystal Onset | | Composition of |
|---|---|---|---|
| Catalyst | Temperature, ° C. | Crystal Phase | the Crystal Phase |
| Lithium | 1165 | Cristobalite | SiO₂ |
| | | Tridymite | SiO₂ |
| Sodium | 1200 | Cristobalite | SiO₂ |
| | | Tridymite | SiO₂ |
| Potassium | Not Observed | — | — |
| Magnesium | Not Observed | Cristobalite | SiO₂ |
| | | Forsterite | Mg₂SiO₄ |
| Calcium | 920 | Cristobalite | SiO₂ |
| Strontium | Not Observed | Cristobalite | SiO₂ |
| | | Strontium silicate | Sr₂SiO₄ |

The crystal onset temperature, the crystal phase, and composition of the crystal phase for the calcium aluminosilicate glass article samples of Example 2 are displayed in Table 7.

TABLE 7
Crystallization of Calcium Aluminosilicate Glass of Example 2

| Nucleation | Crystal Onset | Crystal | Composition of |
|---|---|---|---|
| Catalyst | Temperature, ° C. | Phase | the Crystal Phase |
| Lithium | 725 | Lamite | Ca₂SiO₄ |
| Sodium | Not Observed | — | — |
| Cesium | Not Observed | — | — |
| Calcium | 600 | Calcio-olivine | Ca₂SiO₄ |

The crystal onset temperature, the crystal phase, and composition of the crystal phase for the magnesium aluminosilicate glass article samples of Example 2 are displayed in Table 8.

TABLE 8
Crystallization of Magnesium Aluminosilicate Glass of Example 2

| Nucleation | Crystal Onset | Crystal | Composition of |
|---|---|---|---|
| Catalyst | Temperature, ° C. | Phase | the Crystal Phase |
| Lithium | 675 | Not measured | Not measured |
| Sodium | 670 | Not measured | Not measured |
| Cesium | Not Observed | — | — |
| Calcium | 650 | Calcio-olivine | Ca₂SiO₄ |

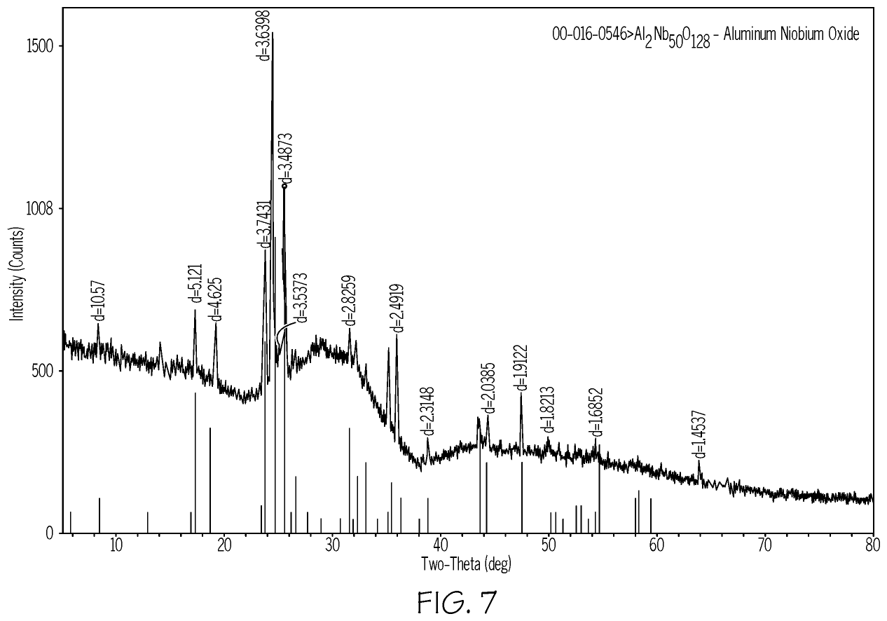

Localized crystallization was achieved in the first and second yttrium aluminosilicate glass articles of Example 2 using the niobium oxide nucleating catalyst. For the first and second yttrium aluminosilicate glasses of Example 2, it was not possible to observe the crystal onset temperature; however, crystals were observed after heating the glass articles to the nucleation temperature. The composition of the crystalline phase in the first yittrium aluminosilicate glass was measured by x-ray diffraction (XRD). The XRD spectrum depicted in FIG. 7 shows that the crystalline phase includes aluminum niobium oxide (Al₂Nb₅₀O₁₂₈).

Localized crystallization was achieved in the sodium aluminosilicate glass of Example 2 using the lithium, magnesium, and calcium inks of Example 1. The crystal onset temperature was not able to be observed; however, crystallization occurred below 900° C. when using each of the inks.

The present disclosure is directed to various embodiments locally crystallized glass articles and of methods for producing localized crystallization in glass articles. In embodiments, methods for producing localized crystallization as described herein may include the steps of depositing an ink onto at least a portion of a surface of a glass article to form an at least partially coated surface; heating the glass article to a nucleation temperature; holding the glass article at the nucleation temperature to form a locally crystallized glass article; and cooling the locally crystallized glass article. Methods for producing localized crystallization in glass articles and glass articles formed therefrom may be used to produce glass or crystalline structures. For example without limitation, the methods described herein may be used to produce glass article having channels in a desired location that may be used as micro-reactors or used in micro-optics. In further examples without limitation, the methods described herein may be used to produce crystalline articles that are highly porous, or include a tight lattice structure.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A method for producing localized crystallization in a glass article, the method comprising:
depositing a nucleation catalyst onto at least a portion of a surface of the glass article to form an at least partially coated surface, wherein the nucleation catalyst is in a solution or in a slurry;
heating the glass article to a nucleation temperature;
holding the glass article at the nucleation temperature to form a locally crystallized glass article comprising a crystalline phase and a non-crystalline phase, wherein one or more portions of the locally crystallized glass article adjacent to the nucleation catalyst comprise the crystalline phase and a remainder of the locally crystallized glass article comprises the non-crystalline phase; and
cooling the locally crystallized glass article.

2. The method of claim 1, wherein the nucleation catalyst comprises a Group 1 metal, a Group 2 metal, a Group 3 metal, a Group 4 metal, or Group 5 metal, or combinations thereof.

3. The method of claim 1, wherein the nucleation catalyst comprises one of (i) lithium, sodium, cesium, calcium, magnesium, strontium, scandium, yttrium, titanium, niobium, or combinations thereof, (ii) a metal carbonate, a metal nitrate, or combinations thereof, or (iii) a metal oxide.

4. (canceled)

5. (canceled)

6. The method of claim 1, wherein the solution or the slurry (i) further comprises water and diethylene glycol, and a weight ratio of water to diethylene glycol is from 2:1 to 1:2 and (ii) has a viscosity from 1 centipoise to 25 centipoise and a surface tension from 20 dynes/centimeter to 50 dynes/centimeter.

7. (canceled)

8. The method of claim 1, wherein the glass article comprises fused silica or aluminosilicate glass.

9. (canceled)

10. (canceled)

11. The method of claim 1, wherein the glass article has one or more of (i) a liquidus temperature from 1,100° C. to 1,750° C. and (ii) a liquidus viscosity of greater than 35,000 poise.

12. (canceled)

13. (canceled)

14. The method of claim 1, wherein the heating the glass article comprises heating the glass article at a rate from 1° C./minute to 10° C./minute.

15. The method of claim 1, wherein the holding the glass article at the nucleation temperature comprises holding the glass article at the nucleation temperature for a time in a range from 1 minute to 60 minutes.

16. The method of claim 1, wherein the nucleation temperature is from 650° C. to 1400° C.

17. (canceled)

18. The method of claim 1, wherein a chemical composition of the crystalline phase is substantially the same as a chemical composition of the non-crystalline phase.

19. The method of claim 1, wherein a chemical composition of the crystalline phase is different from a chemical composition of the non-crystalline phase.

20. The method of claim 1, wherein the method further comprises etching the locally crystallized glass article to remove at least a portion of the crystalline phase or at least a portion of the non-crystalline phase.

21. (canceled)

22. A method for producing localized crystallization in a glass article, the method comprising:
depositing a nucleation catalyst onto at least a portion of a surface of a first glass article to form an at least partially coated surface, wherein the nucleation catalyst is in a solution or in a slurry;
fusing a second glass article to the first glass article to form a fused glass article, wherein the at least partially coated surface is positioned at an interface between the first glass article and the second glass article;
heating the fused glass article to a nucleation temperature;
holding the fused glass article at the nucleation temperature to form a locally crystallized glass article comprising a crystalline phase and a non-crystalline phase, wherein one or more portions of the locally crystallized glass article adjacent to the nucleation catalyst comprise the crystalline phase and a remainder of the locally crystallized glass article comprises the non-crystalline phase; and
cooling the locally crystallized glass article.

23-28. (canceled)

29. The method of claim 22, wherein one or both of the first glass article and the second glass article comprises fused silica.

30. (canceled)

31. The method of claim 22, wherein one or both of the first glass article and the second glass article comprises an aluminosilicate glass.

32. (canceled)

33. The method of claim 22, wherein a composition of the first glass article is substantially the same as a composition of the second glass article.

34-44. (canceled)

45. A locally crystallized glass article comprising:
a crystalline phase; and
a non-crystalline phase, wherein a liquidus viscosity of the non-crystalline phase is greater than or equal to 35,000 Poise.

46. (canceled)

47. The locally crystallized glass article of claim 45, wherein a chemical composition of the crystalline phase is different from a chemical composition of the non-crystalline phase.

48. The locally crystallized glass article of claim 45, wherein a chemical composition of the crystalline phase is substantially the same as a chemical composition of the non-crystalline phase.

49. (canceled)

50. (canceled)

51. The locally crystallized glass article of claim 45, wherein the non-crystalline phase comprises one of:
fused silica,
sodium aluminosilicate glass and the sodium aluminosilicate glass comprises from 11.5 mol. % to 13.5 mol. % Na₂O; from 7.5 mol. % to 17.5 mol. % Al₂O₃; from 70.0 mol. % to 80.0 mol. % SiO₂; and from 0.10 mol. % to 0.20 mol. % SnO2,
calcium aluminosilicate glass and the calcium aluminosilicate glass comprises from 24.0 mol. % to 20.0 mol. % CaO; from 20.0 mol. % to 30.0 mol. % Al₂O₃; from 45.0 mol. % to 55.0 mol. % SiO₂; and from 0.10 mol. % to 0.20 mol. % SnO2,
magnesium aluminosilicate glass and the magnesium aluminosilicate glass comprises from 24.0 mol. % to 26.0 mol. % MgO; from 20.0 mol. % to 30.0 mol. % Al₂O₃; from 45.0 mol. % to 55.0 mol. % SiO₂; and from 0.10 mol. % to 0.20 mol. % SnO2,
yttrium aluminosilicate glass and the yttrium aluminosilicate glass comprises (i) from 23.1 mol. % to 25.1 mol. % Y₂O₃; from 27.3 mol % to 37.3 mol. % Al₂O₃; from 38.5 mol % to 47.5 mol. % SiO₂; and from 0.05 mol. % to 0.15 mol. % SnO2 or (ii) from 27.4 mol. % to 29.4 mol. % Y₂O₃; from 17.9 mol % to 27.9 mol % Al₂O₃; from 43.6 mol % to 53.6 mol. % SiO₂; and from 0.05 mol % to 0.15 mol. % SnO2, or
sodium aluminosilicate phosphate glass and the sodium aluminosilicate phosphate glass comprises from 11.3 mol. % to 13.3 mol. % Na₂O; from 0.4 mol. % to 2.4 mol. % P₂O₅; from 7.3 mol. % to 17.3 mol. % Al₂O₃; from 68.9 mol. % to 78.8 mol % SiO₂; and from 0.05 mol. % to 0.15 mol. % SnO₂.

52-56. (canceled)
